(19) United States
(12) Patent Application Publication
(10) Pub. No.: US 2011/0147423 A1
(43) Pub. Date: Jun. 23, 2011

(54) Bottle and Holder

(76) Inventor: Steven Roy Serpell, Bendigo (AU)

(21) Appl. No.: 12/978,036

(22) Filed: Dec. 23, 2010

Related U.S. Application Data
(63) Continuation-in-part of application No. PCT/AU2009/000803, filed on Jun. 22, 2009.

(30) Foreign Application Priority Data
Jun. 23, 2008 (AU) 2008903169

(51) Int. Cl. B62J 11/00; B65D 23/00

(52) U.S. Cl. 224/414; 215/370

(57) ABSTRACT

A bottle holder for holding a bottle. The bottle holder mechanically couples to an internal portion of the bottle to hold the bottle. The bottle holder may further coupled to a device operated by the user of the bottle, such as a bicycle.

### CROSS-REFERENCE TO RELATED APPLICATIONS

This application is a continuation-in-part of and claims priority under 35 U.S.C. §120 and §365(c) from International Application PCT/AU2009/000803, incorporated herein by reference, with an international fling date of Jun. 22, 2009 and published as WO 2009/155642, which claims priority to Australian application no. 2008903169 filed Jun. 23, 2008.

### FIELD OF THE INVENTION

This invention relates to devices for holding beverages during exercise or travel, and in particular to a bottle and holder which provides a holder for safely maintaining a bottle in place, via an internal fastening means, during exercise and/or travel and enabling said bottle to be easily removed and replaced as required without compromising the aerodynamic and aesthetic appeal of the bottle.

Whilst the invention may be applied to a holder for holding any other suitable item or being applied to any other piece of equipment, for convenience sake it shall be described herein in terms of a bottle and holder that is used during exercise, specifically when on a bicycle.

### BACKGROUND TO THE INVENTION

Many cyclists, both competitive and casual have a bottle holder and bottle located on their bicycle. These bottle holders are generally located on the down tube of the bicycle frame for easy access when riding.

Bottle holders on bicycles generally allow a rider to slide a bottle into a cage or frame assembly that holds the bottle in place. These can be difficult for a rider, since when they try to grasp the bottle they will invariably grasp the cage or frame as well, hampering their efforts to remove the bottle. Also when replacing the bottle, care is needed to ensure the bottle is guided back accurately to ensure that the bottle is replaced correctly potentially distracting the rider, this is particularly the case with cages that completely wrap around the bottle.

Holders that include a clamp are also used by some bicycle riders. These hold the bottle in place with a clamping mechanism. These holders can distract the rider when trying to remove the bottle when opening the clamp, which may result in a serious accident caused by or involving the rider. Replacing the bottle can cause similar problems as placing the bottle within the clamp and then closing the clamp can also distract the rider. The current bottle holders require the bottle to fit within them in order to be held in place, placing a constraint on the external shape of the bottle. This has a major impact on the aerodynamics and aesthetics of the bottle.

Accordingly, it is an object of the present invention to overcome or substantially ameliorate the disadvantages of the prior art by providing a bottle and holder which provides a holder for safely maintaining a bottle in place, via an internal fastening means, during exercise and/or travel and enabling said bottle to be easily removed and replaced as required without compromising the aerodynamic and aesthetic appeal of the bottle.

### SUMMARY OF THE INVENTION

The present invention provides a bottle and holder including; a bottle holder having a frame portion and an internal fastening means; and a bottle including a locating hole to engage with the internal fastening means to releasably mount the bottle to the bottle holder whereby the bottle and holder provides a holder for safely maintaining a bottle in place, via an internal fastening means, during exercise and/or travel and further enabling said bottle to be easily removed and replaced as required without compromising the aerodynamic and aesthetic appeal of the bottle.

According to various aspects of the present invention, an internal fastening means allows the bottle to be held securely in place from within the body portion of the bottle rather than requiring an external attachment from the external surface to the bottle holder.

According to various aspects of the present invention, the mounting frame portion includes at least one, preferably two, arm members which are adapted to be integrally formed with each other, or connected to each other, such that and “L” shape is formed.

A first arm member is adapted to form the base for the holder and allow an internal portion of the base of a bottle to be fastened thereto. A second arm is adapted to provide a means of attachment for the bottle holder to a bicycle or other suitable piece of equipment.

The internal fastening means on the bottle holder is in the form of a locating pin, which is preferably integrally formed with and extends upwardly from the second arm to have a curved inverted conical base extending into a cylindrical stem portion.

The stem portion of the locating pin, preferably the top or end portion of the stem portion, includes a locking means for mechanically coupling to an internal portion of the bottle to keep the bottle securely in place until needed.

The top end of the bottle includes a drinking spout.

The bottle further includes a locating hole formed of an inwardly extending cavity, which includes a frusto-conical opening at the external end, a chamber located at the innermost end, and a passage therebetween.

It is preferred that the passage is preferably made of a flexible material. The passage may further be tapered such that the diameter of the passage at one end of the passage is less than the diameter of the passage at the other end of the passage. In one embodiment, the diameter of the passage at the opening is greater than the diameter of the passage at the chamber.

### BRIEF DESCRIPTION OF THE DRAWING

In order that the invention may be more readily understood we will describe by way of non-limiting example of a specific embodiment thereof, wherein:

FIG. 1 is a typical bottle holder for a bicycle as disclosed in FIG. 1 and comprises a mounting frame, which is attached to the bicycle downtube as shown in FIG. 2 by a cage, which captures the shape of the water bottle;

FIG. 3 is a diagrammatic view of a bottle and holder in accordance with an embodiment of invention;

FIGS. 4A and 4B are overhead cross-sectional views and side elevation respectively of an aerodynamic bottle and holder in accordance with a second embodiment of the invention;

FIG. 5 is a perspective view of a holder of a bottle and holder in accordance with a third embodiment of the invention; and

FIG. 6 is an exploded view of a bottle of a holder and bottle in accordance with a fourth embodiment of invention.

### DETAILED DESCRIPTION OF THE PREFERRED EMBODIMENT

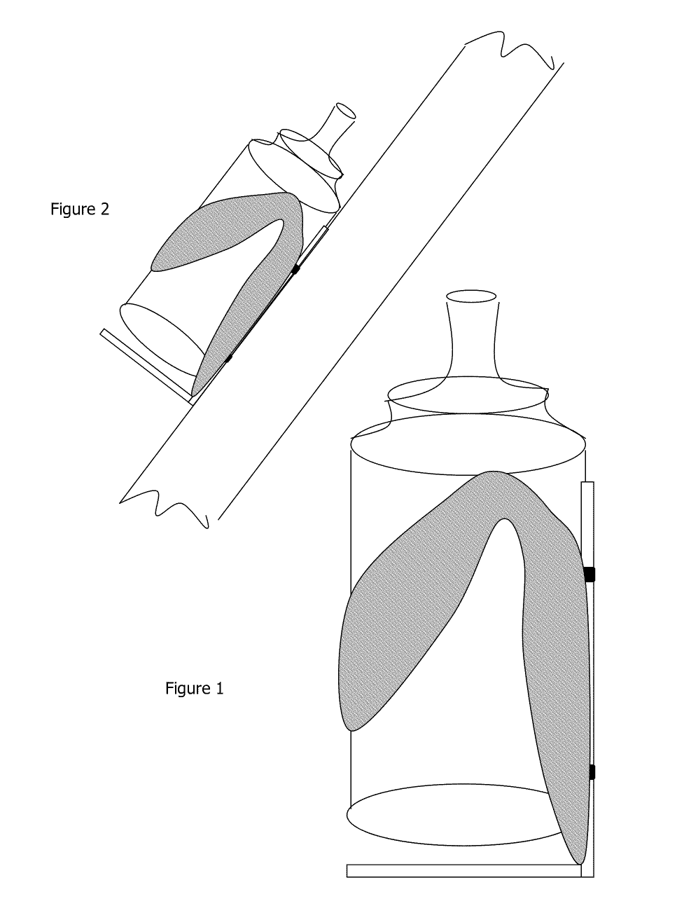

All existing bottle and holder designs are bottle/male, holder/female as shown in FIG. 1 and FIG. 2. A typical bottle holder for a bicycle as disclosed in FIG. 1 comprises a mounting frame, which is attached to the bicycle downtube as shown in FIG. 2, and a cage that captures the shape of the water bottle. Because the bottle must be inserted into the cage to retain the bottle, bottles must have a standard shape to cooperate with the holder to retain the bottle.

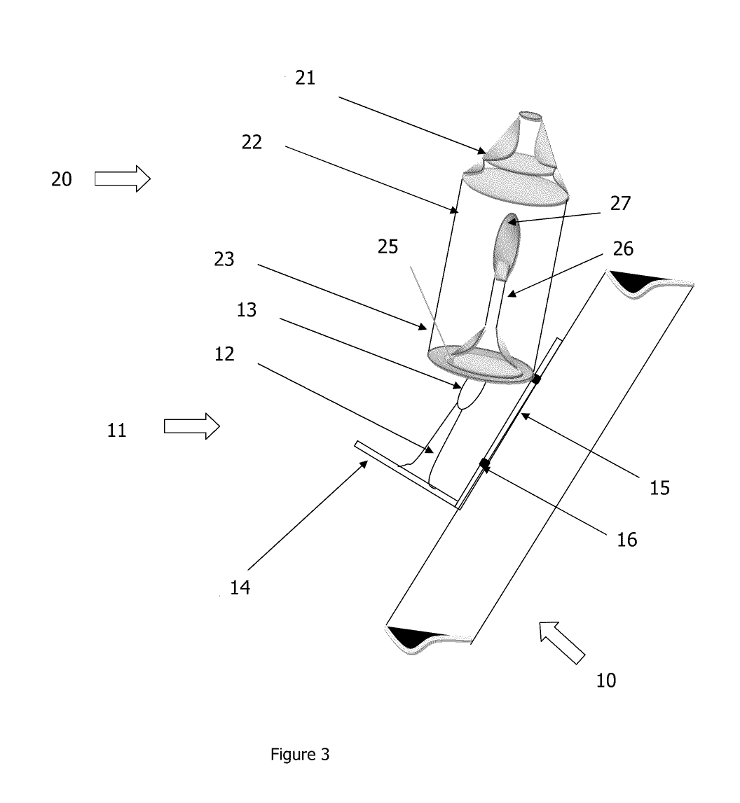

According to various aspects of the present invention, the present invention includes bottle/female and holder/male as shown in FIG. 3.

In the embodiment of FIG. 3, bottle 20 and holder 11 provides a means for maintaining bottle 20 in place via an internal fastening means. The mechanical coupling between an internal portion of bottle 20 and holder 11 retains bottle 20 coupled to holder 11 during exercise and/or travel, yet further enables bottle 20 to be easily removed from and replaced to holder 11 as required without compromising the aerodynamic and aesthetic appeal of the bottle.

The invention shall be described herein in terms of a bottle and holder for use during exercise, specifically when on a bicycle. However, it is envisaged that the bottle may be modified to accommodate other items and/or be applied to other suitable equipment.

The bottle and holder is preferably made of any suitable material which is strong, durable and lightweight. It is further envisaged that the shape, style, dimensions and/or features of the bottle and holder and/or its components may be varied as required to suit the requirements of different bottle types, items, equipment and/or other applications.

The invention has provided a bottle holder 11 for securely holding the bottle 20, via an internal fastening means 12, during exercise and travel. The bottle holder 11 includes a mounting frame portion which is adapted to allow the bottle to be securely held and attached to the bicycle. The mounting frame portion preferably includes at least one arm member. In a preferred embodiment shown in FIG. 3, there are preferably two arm members 14, 15 which are adapted to be integrally formed with each other, or connected to each other, such that and “L” shape is formed. A first arm member 14 is preferably the horizontally attached member which is adapted to form the base for the holder and allow the base of a bottle to be received thereon. The base portion provided an internal fastening means for the bottle so that it can be releasably secured thereto independently of any external fastening to the actual frame portion, unlike existing products. A second arm member 15 is preferably the vertically attached member that is adapted to provide a means of attachment for the bottle holder to a bicycle or other suitable piece of equipment.

Provided on the second arm 15 is preferably at least one aperture which is adapted to receive a suitable securing means 16 therethrough for securing the arm to a shaft, which is the down tube 10 of a bicycle. The securing means 16 is preferably a screw, bolt or the like or any other suitable fastening means. However, it is envisaged that any other suitable means may also be adopted. In a preferred embodiment, the holder is adapted to have the same mounting (screw) pattern as existing bottle cages to easy accommodate exchangeability between existing products and the invention.

The bottle holder 11 preferably has provided an internal fastening means 12 in the form of a locating pin which is adapted to assist a user in securing the bottle 20 and providing an easy means of replacing the bottle during exercise and travel. The locating pin 12 is preferably positioned centrally on the base 14 of the frame portion so that the surrounding base portion can provide support for the bottle. The locating pin is preferably integrally formed with and extends upwardly from the second arm 14 to have a curved inverted conical base extending into a cylindrical stem portion. The stem portion may decrease in diameter (e.g., taper) from the conical base toward the distal end of the stem.

The distal end portion of the stem (e.g., distal end portion of the locating pin) may include locking means 13 for mechanically coupling the locating pin to an internal portion of bottle 20 to hold bottle 20 to holder 11. The locking means may include any structure for mechanically coupling locating pin to an internal portion of bottle 20. A shape of locking means 13 may complement an internal shape of bottle 11 to provide a mechanical interference to fasten bottle 11 to holder 11.

In an embodiment, locking means 13 includes an ovular shaped bulbous head that due to its shape, will expand within a receiving chamber and hold a bottle in place until a user pulls on the bottle to release the grip. The locating pin 12 allows the bottle to be fastened internally within the body of the bottle so that there is not external fastening from the surface of the bottle to the frame of the bottle holder.

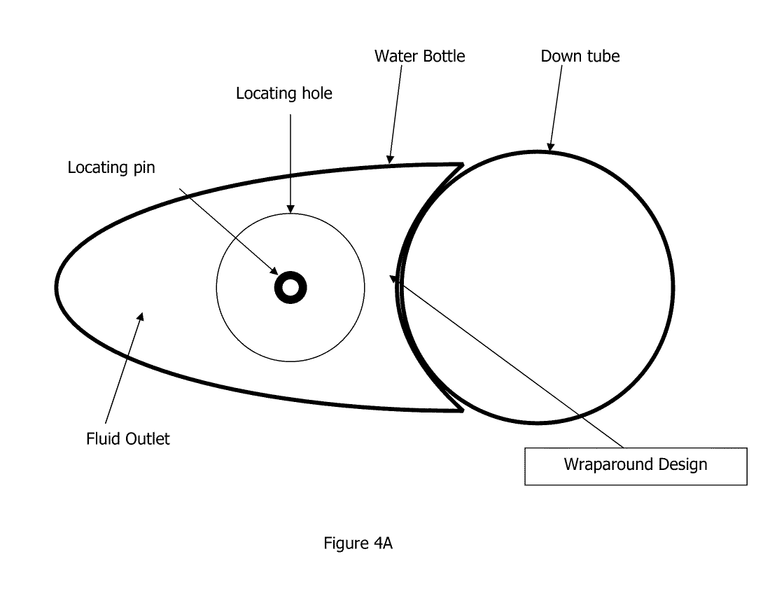

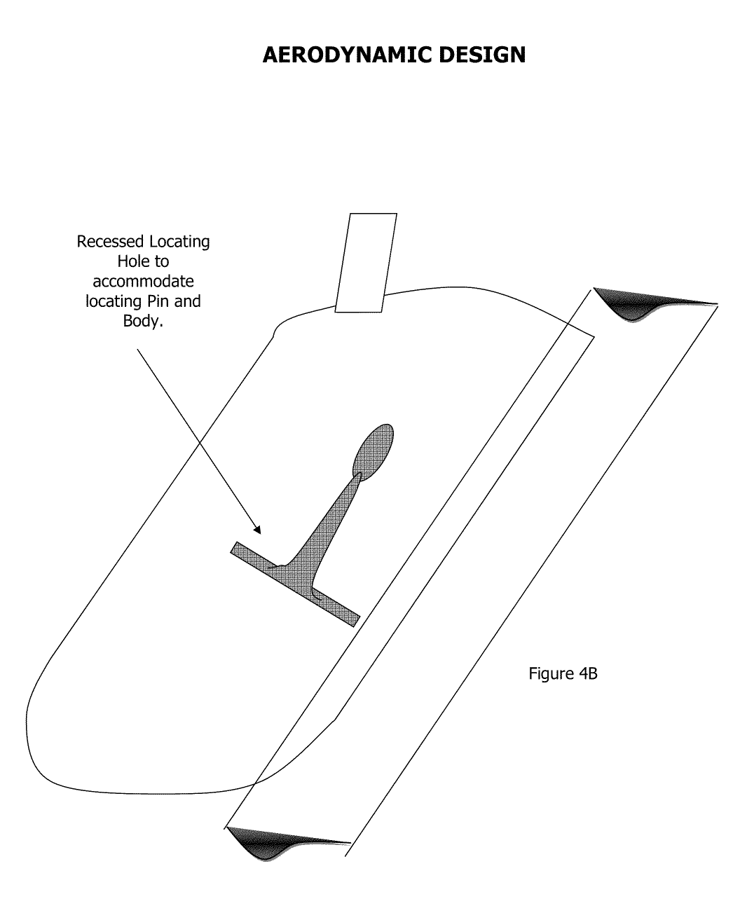

The embodiment shown in FIG. 3 includes bottle 20. Bottle 20 includes a top end 21, a central portion 22 and a bottom end 23. The bottle is preferably made from a polymer or other suitable material that is safe for containing consumable liquids. The bottle 20 is preferably suitably shaped for aerodynamics and aesthetic appeal such as shown in FIGS. 4A and 4B. Provided at the top end 21 of the bottle is preferably a drinking spout. A drinking spout permits the exit of liquids from the bottle. It is envisaged that the top portion of the bottle may be varied as desired to provide different dispensing methods for the bottle. In an embodiment, the bottle is squeezed at a central portion 22 to dispense the liquid. However, a pop-top spout, cap or any other suitable means at the top 21 may be used.

Locating hole 25 is located at bottom end 23 of the bottle. Locating hole 25 is adapted to engage with the internal fastening means 12 of the bottle holder 11. The locating hole 25 is in the form of an inwardly extending cavity 26 which includes a frusto-conical opening at the external end, a chamber 27 located at the innermost end and a passage therebetween. The dimensions and shape of the locating hole may be varied so long as it is substantially complementary in shape to the locating pin which is adapted to be received and held securely therein. The passage is preferably made of a flexible material so that when the locating pin is being inserted into the locating hole, the bulbous head will cause the passage to be elastically deformed and when the head of the locating pin reaches the chamber portion at the end of the locating hole a releasable snap fit will result. A diameter of the passage from the opening to the chamber may decrease (e.g., taper).

It can be seen that an important element is the tapering shape of the hole 25 and the inwardly extending cavity 26 such that it is readily able to receive the internal fastening means 12 easily without the user needing to look. In particular the alignment is initially easily achieved due to the large hole 25 and the tapering provides a smooth guidance until it reaches a locking position. In the embodiment shown the locking means is achieved at a top point but other locking positions are possible as long as the tapering applies.

To remove the bottle from the pin, a cyclist would need to grip the bottle and pull with enough force to overcome the snap fit between the base of the chamber and the bulbous head. When replacing the bottle, the cyclist would place the distal end of the bottle on the pin, having the conical opening assist in locating the passage. Once the passage is located the cyclist would push the bottle down along the pin, having passage walls slightly deform elastically. Once the pin was fully inserted, the bulbous head will sit in the chamber, resulting in the snap fit, and the bottle will be secured in place.

The primary objective of the present invention is to provide a bottle and holder for bicycles that is significantly safer and easier to remove and replace. To provide a bottle and holder that doesn't constrain design needs for aerodynamics, ease of use or aesthetics. This is one form can be achieved by including:
A bottle of any shape that includes an opening as shown in FIG. 3 to receive and/or accommodate a locating pin. This receiving opening or aperture is located in the body of the bottle.
A locating pin that is designed to marry or couple with the aperture or opening located in the bottle FIG. 3. This union is designed to locate and lock the bottle to the holder.

In an alternative embodiment the head of the locating pin is a prism of any shape with a width substantially equal to the width of the stem, and a length larger than the width of the stem pin. The cavity on the bottle in this embodiment includes a passage that is shaped to allow the head and stem to pass through it with little or no deformation to the passage. The cavity chamber is shaped such that when the pin is fully inserted into the cavity, the bottle can be rotated in one direction about the pin to lock it in place or unlock it by rotating it in the opposite direction, allowing it to be removed from the pin.

In a further embodiment of the invention, it is envisaged that the bottle may have provided a handle provided on the outer side walls of the bottle. The handle may preferably be integrally formed with or otherwise attached to the side walls of the bottle. The handle provides a means of simplifying use of the bottle and leverage to remove the bottle from the holder. In an alternate embodiment, the locating pin can preferably be made of a material that can be used to cool or heat the liquid inside the bottle. It is envisaged that the manner in which the bottle is internally fastened to the bottle holder may be vary in further embodiments to suit different materials and/or following further testing.

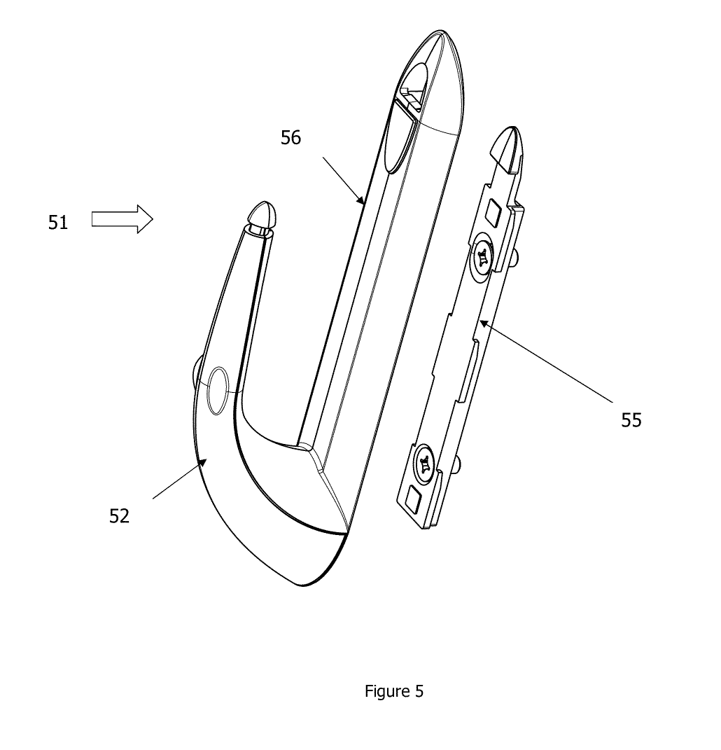

In another embodiment of a holder, referring to FIG. 5, holder 51 includes a first part 55 and a second part 56. First part 55 may be secured to down tube 10 of a bicycle. First part 55 may be secured to down tube 10 in any conventional manner including standardized cage mounting holes that receive the threads of a bolt. Second part 56 overclips and releasably attaches to the first part 55. The second part 56 includes an internal fastening means 52 similar to versions 12 and enables holding of a bottle 20.

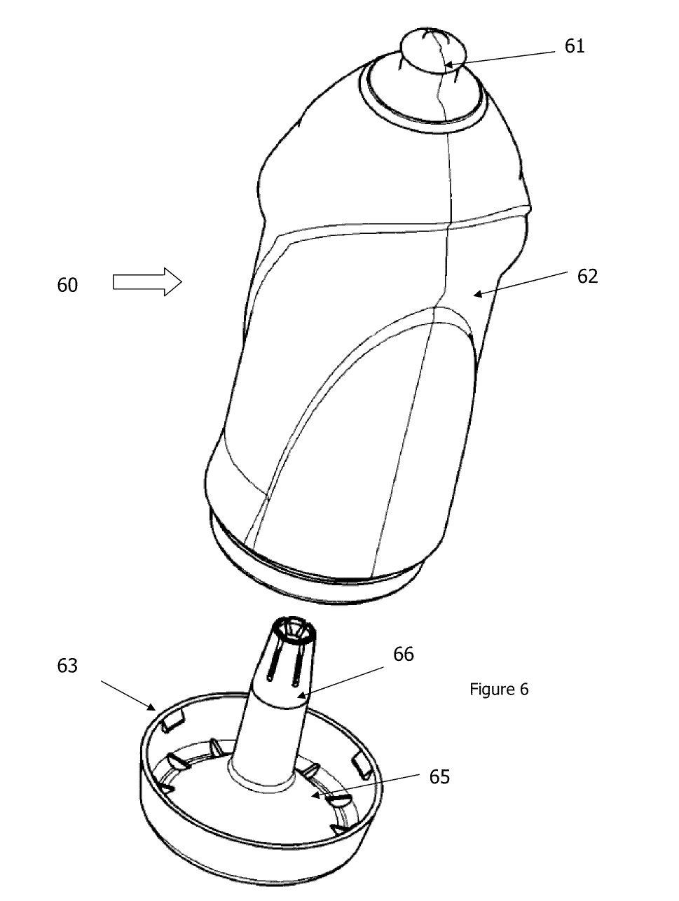

Referring to FIG. 6 there is shown a bottle 60 for insertion onto an internal fastening means such as 12 or 52 of a holder such as 11 or 51. However the bottle is formed of two, and possibly three parts, such that the parts can be separately molded (e.g., formed, manufactured) and mechanically coupled together to form bottle 60. The distinct parts that may form a bottle include top end 61 (21), central portion 62 (22), and bottom end 63 (23).

A top portion may mechanically couple to central portion using any conventional coupling. Top portion may form a closeable opening (e.g., spout, lid, cap) for dispensing a liquid. A central portion may mechanically couple to a bottom end using any conventional coupling. A mechanical coupling may include a coupling that resists the passage of a liquid such that the internal portions of top end 61 (21), central portion 62 (22), and bottom end 63 (23) form an internal cavity inside bottle 60 for holding a liquid.

Bottom end 63 may be molded separately from central portion 62 (22) and top end 61 (21) to form a base shape having an opening 65 (open at bottom of bottom end 63) leading to and continuing a tapering internal passage 66 (inside portion of 66) for receiving the internal fastening means such as 12 or 52 of a holder such as 11 or 51. Prior to coupling bottom end 63 to central portion 62, passage 66 appears to form a hollow protrusion that ends from bottom end 63. Coupling bottom end 63 to central portion 62 positions channel 66 and end portion of channel 66 inside central portion 62 thereby forming a passage and a chamber, as discussed above, internal to bottle 60 with opening 65 positioned at an exterior of bottle 60.

An internal fastening (e.g., locking) mechanism provides a unique solution that provides three main benefits: (1) ease of removal and replacement; (2) aerodynamic freedom (bottle shape); and (3) aesthetic freedom (decal placement not impeded by cage).

While we have described herein various embodiments of a bottle holder and bottle, it is further envisaged that other embodiments of the invention may include any number and combination of any one of the features herein described. However, it is to be understood that any variations and modifications can be made without departing from the spirit and scope thereof.

It can be seen that the present invention relates to a holder and bottle, and more specifically a bicycle bottle and holder and overcomes or at least substantially ameliorates one or more of the key design disadvantages of known bottle/male, holder/female including: (1) an external; holder constrains size and shape of water/liquid bottles; (2) an external holder is generally difficult to remove and replace. First, to remove the bottle a user cannot help but grasp the cage rather than the bottle and the bottle must be removed it in the direction of the bottle holder. Second, to replace the bottle the user must locate the cage without looking and guide the bottle in the direction of the holder.

A primary objective of the present invention is to provide a bottle and holder for bicycles that is significantly safer and easier to remove and replace. To provide a bottle and holder that doesn't constrain design needs for aerodynamics, ease of use or aesthetics. This is achieved at least in part by key design advantages including: (1) by internally fastening the water bottle the external shape can be constructed in any shape or form to suit growing demands of aerodynamics; (2) to remove and relocate the bottle on to the locating pin is a much easier task than the current design, due to the size of the hole and the diameter of the pin (see new design); (3) graphics and decals on external surface of water bottle will no longer be damaged through replacement and removal of bottle; and (4) new bottle design can still be used in old bottle holder.

Further Possibilities of this new design include (1) external handle placed on bottle for ease of use; and/or (2) internal rod to be of such material that it could cool or heat the liquid inside the bottle.

The foregoing description discusses preferred embodiments of the present invention, which may be changed or modified without departing from the scope of the present invention as defined in the claims. Examples listed in parentheses may be used in the alternative or in any practical combination. As used in the specification and claims, the words ‘comprising’, ‘including’, and ‘having’ introduce an open ended statement of component structures and/or functions. In the specification and claims, the words ‘a’ and ‘an’ are used as indefinite articles meaning ‘one or more’. While for the sake of clarity of description, several specific embodiments of the invention have been described, the scope of the invention is intended to be measured by the claims as set forth below.

1. An apparatus for retaining a beverage for access by a bicyclist, the apparatus comprising:
a bottle for retaining the beverage, the bottle comprising an inwardly extending cavity; and
a holder for retaining the bottle, the holder comprising a base and an arm, the arm for coupling to a provided bicycle, the base comprising a pin for coupling to the bottle to retain the bottle; wherein:
the cavity comprises an opening accessible from an exterior of the bottle, a tapering passage extending from the opening and a locking chamber at an inner portion of the cavity, and the passage extending at least between the opening and the chamber;
the pin comprises a bulbous portion spaced from the base of the pin at a corresponding distance to the chamber from the cavity opening;
a diameter of a portion of the chamber is greater than a diameter of a portion of the passage;
the tapering passage allows the locating pin to be readily received into the locating hole and to follow a continuous hindrance free path; and
the chamber receives the bulbous portion to mechanically couple the bottle to the holder.

2. The apparatus of claim 1 wherein the bottle is formed of three interlocking parts that includes a bottom portion having an outer shape for connecting to a central fluid retaining portion which connects to a dispensing top portion that interlocks into a coaxial top opening; the bottom portion including an opening formed by an integral coaxial inner passage for receiving the pin.

3. The apparatus of claim 1 wherein a diameter of the pin decreases between the base and the bulbous portion forming a bulbous head at the end of the tapering passage.

4. The apparatus of claim 1 wherein the diameter of the passage proximate to the chamber is less than the diameter of the portion of the chamber.

5. The apparatus of claim 1 wherein a material that forms the passage flexes to permit the bulbous portion to traverse the passage to enter the chamber.

6. The apparatus of claim 1 wherein a material that forms the passage flexes to permit the bulbous portion to traverse the passage to exit the cavity.

7. The apparatus of claim 1 wherein a wall of the cavity at the opening forms a frustoconical shape.

8. An bottle for retaining a beverage and for removeably coupling to a provided holder, the holder comprising a pin having a bulbous head at a distal end portion of the pin, the bottle comprising:
an inwardly extending cavity; wherein:
the cavity comprises an opening accessible from an exterior of the bottle, a chamber at an innermost portion of the cavity, and a passage between the opening and the chamber;
a diameter of a portion of the chamber is greater than a diameter of a portion of the passage; and
the chamber receives the bulbous head to mechanically couple the bottle to holder.

9. The apparatus of claim 8 wherein the diameter of the passage proximate to the chamber is less than the diameter of the portion of the chamber.

10. The apparatus of claim 8 wherein a material that forms the passage flexes to permit the bulbous head to traverse the passage to enter the chamber.

11. The apparatus of claim 8 wherein a material that forms the passage flexes to permit the bulbous head to traverse the passage to exit the cavity.

12. The apparatus of claim 8 wherein an inside diameter the inwardly extending cavity tapers from a first diameter to a second diameter between the opening and the chamber.

13. The apparatus of claim 8 further comprising a bottom end portion and a central portion, wherein:
the bottom end portion is formed separately from the central portion and mechanically coupled to the central portion to form an internal hollow portion for retaining the beverage;
the bottom end portion comprises a hollow protrusion;
mechanically coupling the bottom end portion to the central portion positions the hollow protrusion inside the central portion to form the inwardly extending cavity.

14. An holder for coupling a bottle to a provided bicycle, the bottle comprising a cavity, the cavity comprising an opening accessible from an exterior of the bottle, a chamber at an innermost portion of the cavity, and a passage between the opening and the chamber, wherein a diameter of a portion of the chamber is greater than a diameter of a portion of the passage, the holder comprising:
an arm for mechanically coupling to the bicycle;
a base mechanically coupled to the arm;
a pin mechanically coupled to the base; wherein:
the pin comprises a bulbous head on an end portion of the pin opposite the base;
the chamber receives the bulbous head to mechanically couple the bottle to the base; and
a diameter of bulbous head is greater than a diameter of a portion of the passage.

15. The apparatus of claim 14 wherein a diameter of the pin decreases between the base and the bulbous head.

16. The apparatus of claim 14 wherein a material that forms the passage flexes to permit the bulbous head to traverse the passage to enter the chamber.

17. The apparatus of claim 14 wherein a material that forms the passage flexes to permit the bulbous head to traverse the passage to exit the cavity.
